(19) United States
(12) Patent Application Publication
(10) Pub. No.: US 2018/0131832 A1
(43) Pub. Date: May 10, 2018

(54) IMAGE SENSOR UNIT, PAPER SHEET DISTINGUISHING APPARATUS, IMAGE READING APPARATUS, AND IMAGE FORMING APPARATUS

(71) Applicant: CANON COMPONENTS, INC., Kodama-gun (JP)

(72) Inventors: Yoshihiko TSUMEKAWA, Saitama (JP); Hidemasa YOSHIDA, Saitama (JP); Satoshi OTA, Saitama (JP); Masaki EHARA, Saitama (JP)

(21) Appl. No.: 15/800,528

(22) Filed: Nov. 1, 2017

(30) Foreign Application Priority Data
Nov. 4, 2016 (JP) 2016-216448
Oct. 27, 2017 (JP) 2017-208127

(51) Int. Cl. H04N 1/028; F21V 13/04; F21V 8/00

(52) U.S. Cl. CPC H04N 1/02855; H04N 1/02865; G02B 6/0033; F21V 13/04; H04N 1/0289

(57) ABSTRACT

An image sensor unit includes a light source that emits light, and a light guide that guides the light from the light source to an object to be illuminated. The light guide includes a linearly elongated rod-like rod portion provided with a light emission surface from which light is emitted to the object to be illuminated, and a curved portion which is integrally connected to an end in the longitudinal direction of the rod portion, includes a light entering surface where the light emitted from the light source is emitted on an end of a side opposite to the rod portion and in which the center line is curved. A reflection member that reflects light is provided to be in close contact with at least a part of a surface of the curved portion.

### CROSS-REFERENCE TO RELATED APPLICATIONS

This application is based upon and claims the benefit of priority of the prior Japanese Patent Application No. 2016-216448, filed on Nov. 4, 2016, and the Japanese Patent Application No. 2017-208127, filed on Oct. 27, 2017, the entire contents of which are incorporated herein by reference.

### BACKGROUND OF THE INVENTION

### Field of the Invention

The present invention relates to an image sensor unit, a paper sheet distinguishing apparatus, an image reading apparatus, and an image forming apparatus.

### Description of the Related Art

There is an image sensor unit that is applied to a paper sheet distinguishing apparatus, an image reading apparatus and an image forming apparatus, and includes a light source, and an elongated light guide that linearizes light emitted from the light source and emits the light toward an object to be illuminated (achieves a linear light source). Such a light guide has an elongated rod-like shape as a whole. An end thereof in the longitudinal direction is provided with a light entering surface which light emitted from the light source enters (is incident on). A side surface in the longitudinal direction is provided with a light emission surface from which the incident light is emitted toward the outside (object to be illuminated).

Patent Document 1 discloses, as such a light guide, a configuration which includes a linearly elongated rod-like portion provided with a light emission surface, and a portion which is provided at an end of the linearly elongated rod-like portion in the longitudinal direction and is curved downward and in which an end surface of the curved portion (i.e., a lower surface) is provided with a light entering surface. Light having entered the light entering surface passes through the curved portion, reaches the linearly elongated rod-like portion, and is emitted from the light emission surface provided at the linearly elongated rod-like portion toward the object to be illuminated.

For the sake of increasing the amount of light emitted from the image sensor unit toward the object to be read, it is preferable that light having been emitted from the light source and having entered the light entering surface of the light guide reach the light emission surface without leaking from the light guide. However, the curved portion of the light guide is prone to leaking light.

### Patent Document 1

Japanese Laid-open Patent Publication No. 2013-31152

### SUMMARY OF THE INVENTION

In view of the situations described above, an object to be achieved by the present invention is to suppress light leaking from the curved portion included in the light guide.

To solve the problem, the present invention is an image sensor unit includes: a light source; a light guide that guides light from the light source to an object to be illuminated; and a photoelectric conversion element that converts light from the object to be illuminated into an electric signal, wherein the light guide includes a rod portion, and a curved portion provided at an end of the rod portion, the curved portion includes a light entering surface on which the light emitted from the light source is incident, and guides the light to the rod portion by changing a traveling direction of the light having entered the light entering surface, the image sensor unit further includes a reflection member that reflects the light, and the reflection member is in close contact with a surface of the curved portion.

### BRIEF DESCRIPTION OF THE DRAWINGS

FIG. 1 is an exploded perspective view schematically showing a configuration example of an image sensor unit;

FIG. 2 is a perspective view schematically showing an appearance of the configuration example of the image sensor unit;

FIG. 3 is a sectional view schematically showing the configuration example of the image sensor unit;

FIG. 4 is a sectional view showing a section taken along a plane perpendicular to a sub-scan direction at the proximity of an end on a proximal end side of a light guide;

FIG. 5A is a side view of the proximity of the end on the proximal end side of the light guide in view of the sub-scan direction;

FIG. 5B is a side view of the proximity of the end on the proximal end side of the light guide in view of the sub-scan direction;

FIG. 5C is a side view of the proximity of the end on the proximal end side of the light guide in view of the sub-scan direction;

FIG. 6 is a diagram schematically showing a configuration example of a main part of a paper sheet distinguishing apparatus;

FIG. 7 is a perspective view schematically showing an appearance of the configuration example of an image reading apparatus (image forming apparatus); and

FIG. 8 is a perspective view schematically showing a configuration example of an image forming unit of an image reading apparatus (image forming apparatus).

### DETAILED DESCRIPTION OF THE PREFERRED EMBODIMENTS

Hereinafter, embodiments to which the present invention is applicable are described in detail with reference to the drawings. The embodiments of the present invention represent an image sensor unit, and a paper sheet distinguishing apparatus and an image reading apparatus (image forming apparatus) to which the image sensor unit is applied. In each diagram, the three-dimensional directions of the image sensor unit are indicated by X, Y and Z arrows. The X-axis direction is the main-scan direction. The Y-axis direction is the sub-scan direction. The Z-axis direction is the vertical direction. As for the main-scan direction, a side where a light source is disposed is called “proximal end side”, and the opposite side is called “distal end side”. As for the vertical direction, a side oriented toward an object P to be illuminated during usage is regarded as an upper side, and the opposite side is regarded as a lower side. In the present invention, “light” encompasses not only visible light but also electromagnetic waves, such as infrared rays and ultraviolet rays, having wavelength ranges other than the wavelength range of visible light.

The image sensor unit according to the embodiment of the present invention emits light toward the object P to be illuminated (object to be read) that relatively moves in the sub-scan direction, and reads an image of the object P to be illuminated, using light from the object P to be illuminated. The image sensor unit according to the embodiment of the present invention conforms to both of reflection reading and transmission reading of the object P to be illuminated. For example, arrangement of two image sensor units in a manner opposite to each other can achieve transmission reading of the object P to be illuminated, and reflection reading of both the sides.

### <Image Sensor Unit>

### (Entire Configuration)

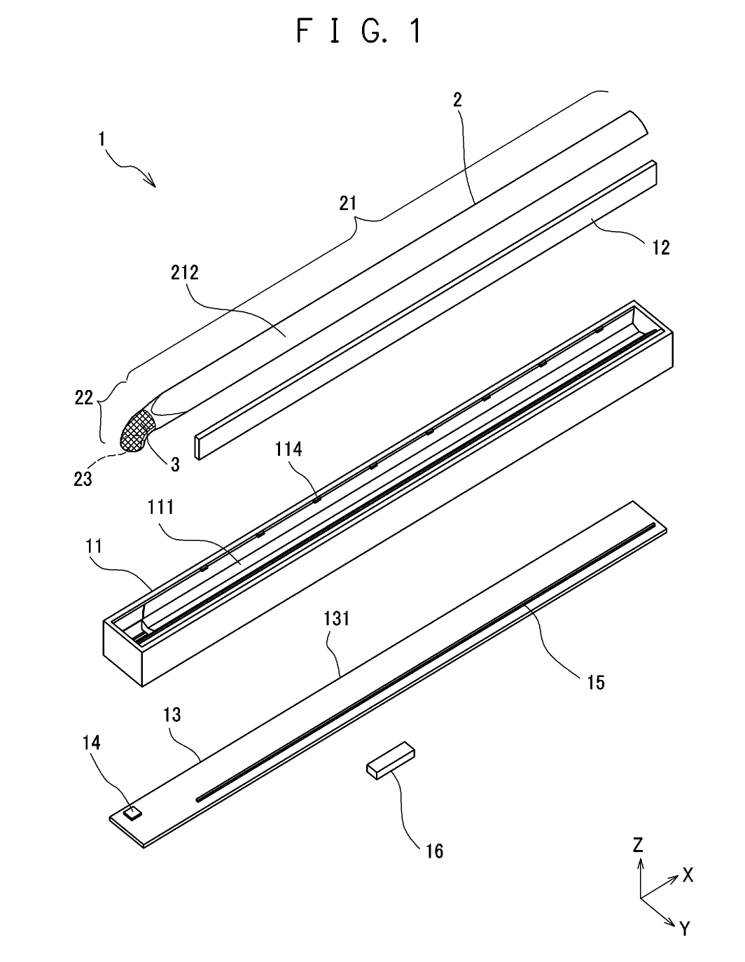

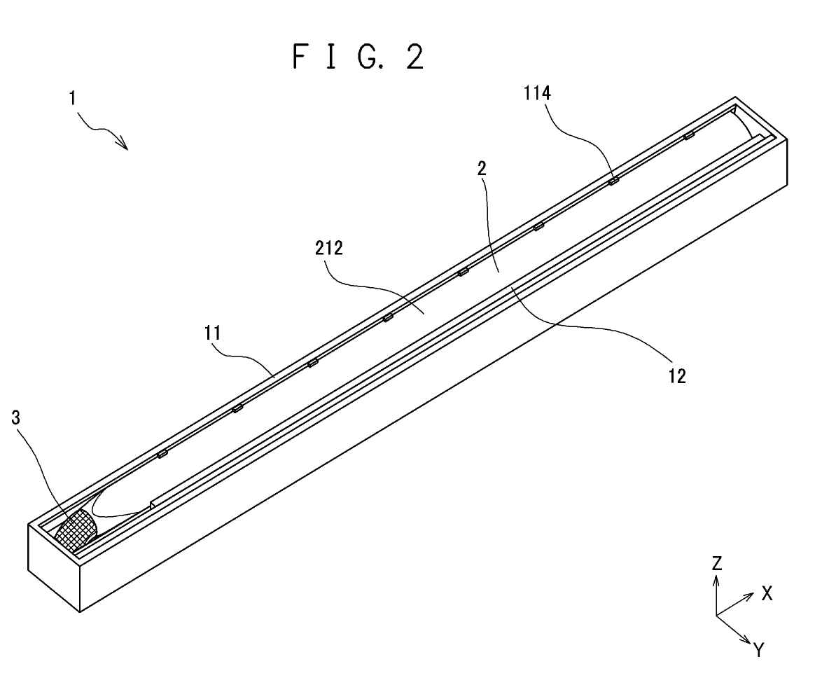

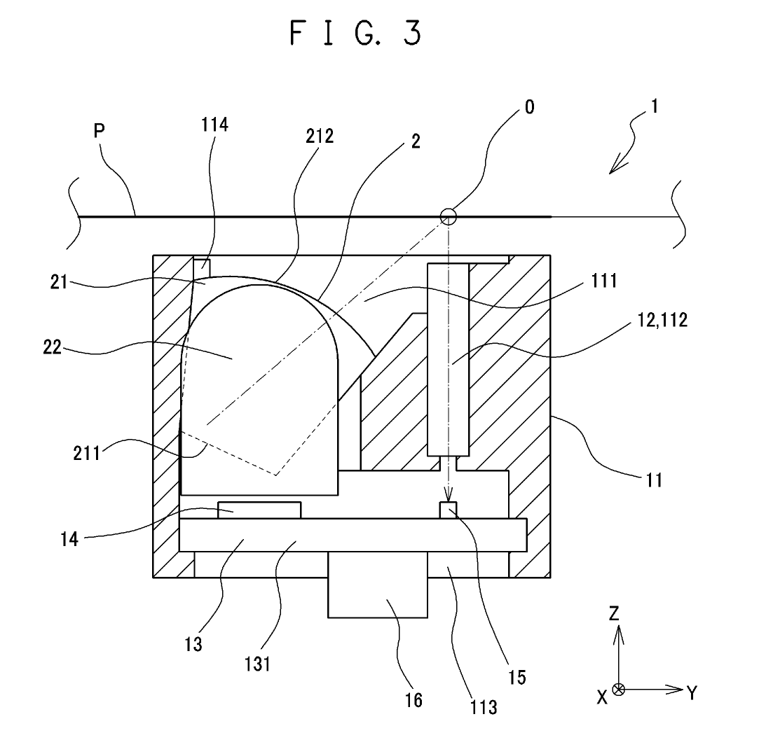

First, the entire configuration example of an image sensor unit 1 according to an embodiment of the present invention is described with reference to FIGS. 1 to 3. FIG. 1 is a schematic exploded perspective view of the configuration example of the image sensor unit 1. FIG. 2 is a perspective view schematically showing an appearance of the configuration example of the image sensor unit 1. FIG. 3 is a diagram schematically illustrating the configuration example of the image sensor unit 1 in view of the main-scan direction, and shows a sectional state of a frame 11 taken along a plane perpendicular to the main-scan direction. As shown in FIGS. 1 to 3, the image sensor unit 1 according to the present invention includes a main circuit board 13, a light guide 2, a light condenser 12, and the frame 11. The main circuit board 13 is provided with a light source 14, an image sensor 15, and a connector 16.

The light source 14 is provided for the main circuit board 13, and emits light toward a later-described light entering surface 23 of the light guide 2. For example, a surface-mount LED that emits light having wavelengths of red (R), green (G), blue (B), infrared (Ir) and ultraviolet (UV) rays is applicable as the light source 14. In a case where the light source 14 is a surface-mount light emitting element, such as an LED, the light source 14 is mounted on the upper surface of the main circuit board 13 so that the light source 14 can emit light upward. Note that the light source 14 is not limited to the surface-mount light emitting element. The wavelength range of light emitted from the light source 14 is appropriately configured according to the specifications of the image sensor unit 1 and the type of the object P to be illuminated, which is the corresponding object to be read, and is not specifically limited.

The light guide 2 is an optical member that linearizes light emitted from the light source 14 (achieves a linear light source), and emits the light to the outside (a reading line O on the object P to be illuminated). The light guide 2 includes a rod portion 21 having a rod-like shape linearly elongated in the main-scan direction, and a curved portion 22 that extends from the end on the proximal end side in the main-scan direction (longitudinal direction) of the rod portion 21 and is bent downward, and has a rod-like shape elongated in the main-scan direction as a whole. At an end of the curved portion 22, a light entering surface 23 for emitting light from the light source 14 is provided. The rod portion 21 is provided with a light diffusion surface 211 that diffuses incident light, and a light emission surface 212 that emits light toward the reading line O on the object P to be illuminated. The light guide 2 is made of, for example, a transparent material, such as an acrylic resin material. The rod portion 21 and the curved portion 22 are integrally formed. For example, injection molding is applied to a method of manufacturing the light guide 2. In this case, the rod portion 21 and the curved portion 22 of the light guide 2 are integrally formed by injection molding. The detail configuration of the light guide 2 is described later.

The light condenser 12 is an optical member that focuses (condenses) reflected light from the object P to be illuminated and transmission light, on a light receiving surface of the image sensor 15 (described later). For example, a rod lens array is applied to the light condenser 12. The rod lens array includes multiple erect equal magnification imaging type imaging elements (rod lenses), these imaging elements being linearly arranged in the main-scan direction. The light condenser 12 may have any configuration of including multiple imaging elements arranged linearly in the main-scan direction. For example, the number of arrays of imaging elements is not specifically limited, and a configuration provided with multiple arrays of imaging elements may be adopted. The light condenser 12 is not limited to the rod lens array. An optical member having any of various publicly known imaging functions (condensing functions) is applicable.

The main circuit board 13 is a circuit board provided with the light source 14, the image sensor 15, and the connector 16. As shown in FIGS. 1 and 3, the main circuit board 13 includes: a wiring board 131 elongated in the main-scan direction; the light source 14 and the image sensor 15 that are provided on the upper surface of the wiring board 131; and a connector 16 provided on the lower surface of the wiring board 131.

The image sensor 15 converts the light focused by the light condenser 12 into an electric signal, and outputs the signal. The image sensor 15 is provided with a light receiving surface oriented upward so that the light having passed through the light condenser 12 can be received. For example, an image sensor IC array is applied to the image sensor 15. The image sensor IC array is formed by mounting multiple image sensor ICs on the upper surface of the wiring board 131 in the main-scan direction. The image sensor ICs each include multiple photoelectric conversion elements. A predetermined number of image sensor ICs are mounted on the upper surface of the wiring board 131 to be arranged in the main-scan direction so that a certain number of photoelectric conversion elements in conformity with the number of pixels in the main-scan direction of reading by the image sensor unit 1 can be arranged in the main-scan direction. The image sensor 15 may have any configuration where the certain number of photoelectric conversion elements in conformity with the number of pixels in the reading main-scan direction are arranged linearly in the main-scan direction at pitches in conformity with the reading resolution. The configuration is not limited to a specific one. For example, a configuration may be adopted where multiple image sensor ICs including multiple photoelectric conversion elements are arranged in a staggered manner. Alternatively, another configuration may be adopted where these ICs are arranged in multiple arrays. Various publicly known image sensor ICs are applicable to the image sensor ICs constituting the image sensor 15.

The connector 16 is provided in order to connect the main circuit board 13 electrically to the outside. The configuration of the connector 16 is not specifically limited. Any of various publicly known connectors is applicable as this connector.

The frame 11 is a casing of the image sensor unit 1. The frame 11 has the shape of a rectangular parallelepiped elongated in the main-scan direction as a whole, for example, and is integrally formed of a material having a light blocking property. Polycarbonate that is colored black is applicable as such a material. In the embodiment of the present invention, the frame 11 may has a function as a cover with which the light guide 2 is covered. In this case, to prevent light having leaked out of the light guide 2 from being reflected by the inner surface of the frame 11 and re-entering the light guide 2, it is preferable that the reflectance of the inner surface of the frame 11 be less than 60%, and it is further preferable that the reflectance be less than 30%. In this case, it is preferable that the color be black as described above.

The frame 11 is provided with a light guide housing 111, a light condenser housing 112, and a main circuit board housing 113. The light guide housing 111 is a region for housing the light guide 2. The light condenser housing 112 is a region for housing the light condenser 12. The light guide housing 111 and the light condenser housing 112 are each a region having a groove or concave shape that is open upward. Their longitudinal directions are parallel to the main-scan direction and are parallel to each other. The main circuit board housing 113 is a region for housing the main circuit board 13, and is a region that is elongated in the main-scan direction and has a groove or concave shape that is open downward. The main circuit board housing 113 is provided below the light guide housing 111 and the light condenser housing 112. The proximity of the end on the proximal end side in the main-scan direction of the light guide housing 111 (the portion that houses the curved portion 22 of the light guide 2), and the main circuit board housing 113 communicate with each other through an opening having a through-hole shape penetrating in the vertical direction. An optical path that allows light having passed through the light condenser 12 to pass is provided between the light condenser housing 112 and the main circuit board housing 113. A slit-shaped through-hole that is elongated in the main-scan direction and penetrates in the vertical direction is applied to this optical path.

The image sensor unit 1 further includes a frame cover with which the upper side of the frame 11 is covered. For example, a configuration of a planar shape elongated in the main-scan direction is applicable as the frame cover. At least portions that serve as an optical path of light emitted from the light emission surface 212 of the light guide 2, and an optical path of light from the object P to be illuminated are transparent. For example, a plate made from a transparent resin material, such as acrylic, a glass plate or the like is applied to the frame cover. In the configuration where the image sensor unit 1 includes the frame cover, the frame cover has a function of protecting each member housed in the frame 11, a function of preventing foreign matters, such as dust, from entering the frame 11, and a function of holding the object P to be illuminated in a planer manner in a case where the object P to be illuminated is a paper sheet or the like.

The frame 11 may have a function as a cover with which the light guide 2 is covered. Alternatively, instead of the frame 11, a cover with which the light guide 2 is covered may be included. In the case where the cover with which the light guide 2 is covered is provided independent of the frame 11, the reflectance of the inner surface of the frame 11 is not necessarily as that described above.

### (Image Sensor Unit Assembling)

Next, a configuration of assembling the image sensor unit 1 is described. The light guide 2 is housed in the light guide housing 111 from the upper side of the frame 11. The frame 11 is provided with a certain number of light guide holders 114 that hold the light guide 2. The light guide 2 housed in the light guide housing 111 is held in a state of being positioned in the frame 11 by the light guide holders 114. The light guide holders 114 may have any configuration that can hold the light guide 2 in the state of being positioned. The configuration is not limited to a specific one. Another configuration may be adopted that includes the light guide holders separated from the frame 11.

The light condenser 12 is housed in the light condenser housing 112 from the upper side of the frame 11. This condenser is fixed in a state of being positioned to the frame 11 with adhesive or the like. For example, the light condenser 12 is positioned so that the upper focal point can be positioned on or proximity to the reading line O, and the lower focal point can be positioned on the light receiving surface of the image sensor 15. For example, ultraviolet curable adhesive is applicable to fixation of the light condenser 12.

The light source 14 is mounted on the upper surface of the wiring board 131 so as to emit light toward the light entering surface 23 of the light guide 2. The image sensor 15 is provided on the upper surface of the wiring board 131 so as to allow the light incident from the upper side to be detected. The connector 16 is provided on the lower surface of the wiring board 131. The main circuit board 13, which includes the light source 14 and the image sensor 15 and the connector 16, is housed in the main circuit board housing 113 from the lower side and is fixed to the frame 11. A fixation structure of the main circuit board 13 is not specifically limited. For example, a configuration of fixing using adhesive, or a configuration of fixing by caulking a part of the frame 11, is applicable.

As shown in FIG. 3, in the case where the light guide 2 is housed in the light guide housing 111 and the main circuit board 13 is housed in the main circuit board housing 113, the end on the proximal end side of the curved portion 22 of the light guide 2 is in a state of being in an opening provided so as to cause the light condenser housing 112 and the main circuit board housing 113 to communicate with each other. The light source 14 of the main circuit board 13 faces the light emission surface 212 provided on the end surface of the curved portion 22 of the light guide 2. Consequently, light emitted upward from the light source 14 enters the light entering surface 23 of the light guide 2. The light receiving surface of each photoelectric conversion element of the image sensor 15 on the main circuit board 13 is positioned on the optical axis of the light condenser 12 housed in the light condenser housing 112 and the lower focal point of the lower side of the light condenser 12. According to such a configuration, the light from the object P to be illuminated focuses on the light receiving surface of each photoelectric conversion element of the image sensor 15 through the light condenser 12.

### (Light Guide)

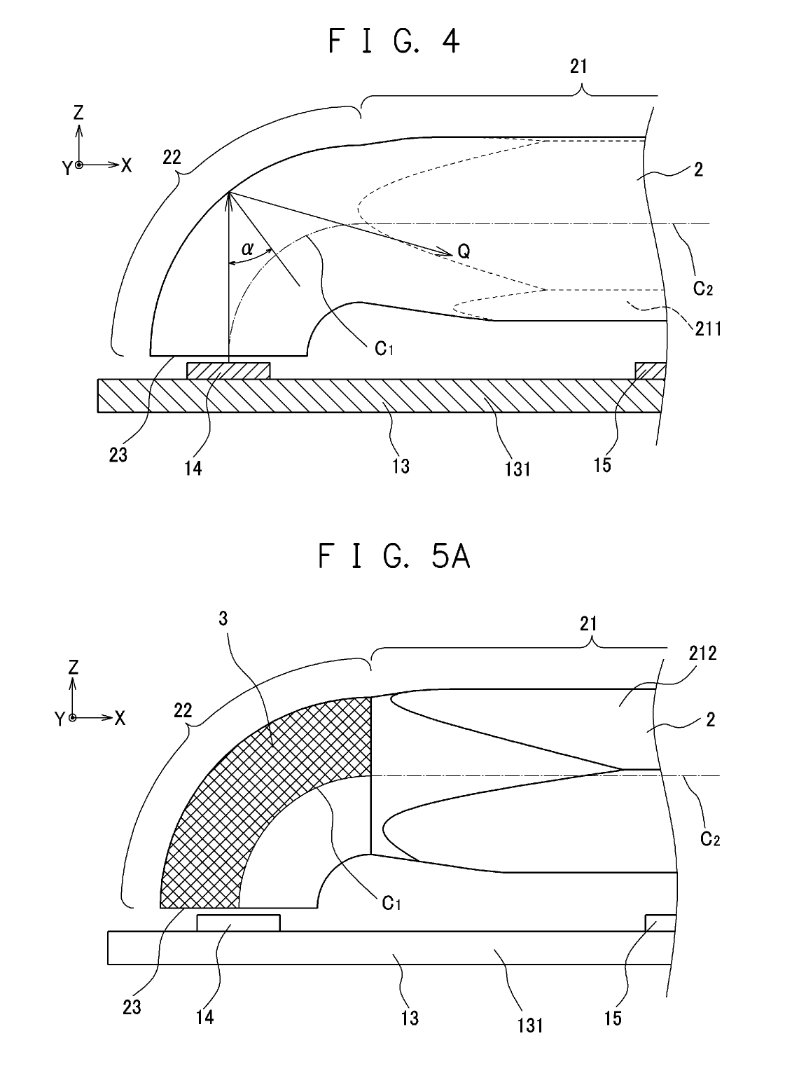

Next, a configuration example of the light guide 2 is described with reference to FIG. 4 and the like. FIG. 4 is a sectional view showing a section taken along a plane perpendicular to the sub-scan direction at the proximity of the end on the proximal end side of the light guide 2. The light guide 2 includes the linearly elongated rod-like rod portion 21, and the curved portion 22 provided to extend from the end on the proximal end side of the rod portion 21. The rod portion 21 and the curved portion 22 are integrally formed. An arrow Q in FIG. 4 is an arrow that schematically indicates light traveling through the inside of the light guide 2.

The rod portion 21 is a portion of a straight line on which the center line C₂ extends in the main-scan direction. The outer surface of the rod portion 21 is provided with the light emission surface 212 and the light diffusion surface 211 (see FIG. 3). The light emission surface 212 is a surface from which linear light elongated in the main-scan direction is emitted toward the reading line O on the object P to be illuminated and which has a shape elongated in the main-scan direction. The light emission surface 212 is formed to have a shape which allows the emitted light to concentrate on the reading line O on the object P to be illuminated, for example, a curved surface convex toward the reading line O on the object P to be illuminated in view of the main-scan direction. The light diffusion surface 211 is a surface that allows the light traveling in the light guide 2 to diffuse (scatter), and is provided with an optical diffusion pattern for diffusing (scattering) the light. As with the light emission surface 212, the light diffusion surface 211 has a shape elongated in the main-scan direction, and is provided in parallel to the light emission surface 212 on the opposite side of the light emission surface 212 so that the light diffused (scattered) by the light diffusion surface 211 can be emitted from the light emission surface 212 (see FIG. 3). The optical diffusion pattern is configured to have a degree of light diffusion that increases as the position approaches the distal end of the main-scan direction. For example, a dot pattern made of paint that scatters light is applied as the optical diffusion pattern. In this case, the density of the dot pattern increases as the position approaches the distal end. A surface that is of the outer surface of the rod portion 21 and is other than the light emission surface 212 and the light diffusion surface 211 functions as a light reflecting surface that reflects light traveling through the inside of the light guide 2.

The curved portion 22 is provided integrally with the rod portion 21 on the proximal end side of the light guide 2 in the main-scan direction (longitudinal direction), and is curved downward while further extending from the end on the proximal end side of the rod portion 21. In other words, the curved portion 22 is a portion whose center line C₁ extends in a direction intersecting with the center line C₂ of the rod portion 21. The curved portion 22 may be a portion extending in the direction intersecting with the longitudinal direction of the rod portion 21. For example, the center line C₁ of the curved portion 22 is curved to have an arc shape in view of the sub-scan direction, is parallel (parallel in the main-scan direction) to the center line C₂ of the rod portion 21 at the boundary with the rod portion 21, and is substantially parallel to the vertical direction at the end on the proximal end side (the end on the side opposite to the rod portion 21). The curvature radius of the curved surface of the curved portion 22 is not necessarily constant (in other words, the center line C₁ of the curved portion 22 is not necessarily a curve taken from a part of a circle). For example, the center line C₁ of the curved portion 22 may be a curve taken from a part of an ellipse, a curve represented by any of various other functions, or a free curve difficult to be represented by a function. One end (end on the proximal end side) (end surface) of the curved portion 22 in the center line direction is oriented downward, and the light entering surface 23 is provided on this end (end surface). The entire end (end surface) of the curved portion 22 on the proximal end side may be configured to be the light entering surface 23. Alternatively, the light entering surface 23 may be configured to be provided on a part of the end. The sectional shape of the curved portion 22 in a case of taking along a plane perpendicular to the center line C₁ is not specifically limited. For example, a circle, an ellipse or the like is applicable thereto.

According to such a configuration, the light having been emitted from the light source 14 and having entered the inside of the curved portion 22 of the light guide 2 from the light entering surface 23 is reflected by the surface (the interface with the outside) of the curved portion 22 during travel through the curved portion 22, and the traveling direction is changed, and the light reaches the rod portion 21. The light having reached the rod portion 21 travels toward the distal end of the rod portion 21, and is emitted from the light emission surface 212 toward the reading line O on the object P to be illuminated.

When the incident angle α of the light incident on the surface of the curved portion 22 is larger than the critical angle, the incident light is totally reflected. When the incident angle α is less than the critical angle, a part of the light becomes light leaking to the outside of the light guide 2. If the amount of leaking light becomes large, the amount of light reaching the rod portion 21 decreases. Accordingly, the amount of light emitted from the light emission surface 212 toward the reading line O on the object P to be illuminated also decreases. Consequently, for the sake of increasing the amount of light emitted from the light emission surface 212 while reducing the waste of light (suppressing reduction), it is preferable to suppress the leaking light at the curved portion 22. Suppression of the leaking light can facilitate reduction in power consumption.

A configuration is adopted where a reflection member 3 that reflects incident light is provided in a predetermined range on the surface of the curved portion 22. This configuration suppresses the light leaking from the curved portion 22 to facilitate reduction in waste of light. The reflection member 3 is provided so as to be in close contact with the predetermined range on the surface of the curved portion 22 (so that no gap can be present between the surface of the curved portion 22 and the reflection member 3). A configuration where the reflection member 3 is provided so as to be in close contact with the surface of the curved portion 22 can prevent light from leaking from the gap between the surface of the curved portion 22 and the reflection member 3. In comparison with the configuration without close contact (the configuration with the gap), the optical path of light reflected by the reflection member 3 can be reduced. Consequently, the attenuation of the reflected light can be suppressed.

For example, a stacked layer or a pasted film made of a material having a high reflectance (or containing a material having a high reflectance) is applied as the reflection member 3. A configuration is applicable where the stacked layer and the pasted film are provided so as to be in close contact with the predetermined range of the surface of the curved portion 22 as the reflection member 3. For example, a configuration where paint (configuration with paint) or plating (configuration with a plating layer) is applied is applied as the stacked layer. For example, a configuration where a sheet or the like made of a material having a high reflectance (or containing a material having a high reflectance) is pasted so as to be in a close contact is applicable as the pasted film.

Any of various types of white paint and silver paint is applicable as the paint made of a material having a high reflectance (or containing a material having a high reflectance). In this case, printing (application) with such paint directly to a predetermined range on the surface of the curved portion 22 forms the reflection member 3 in close contact with the surface of the curved portion 22. For example, non-electrolytic plating is applicable to formation of the plating layer as the reflection member 3. In this case, formation of the plating layer directly on the surface of the curved portion 22 of the light guide 2 forms the reflection member 3 in close contact with the surface of the curved portion 22. A seal (mirror surface seal) that includes a reflection layer and a layer of adhesive or an adhesive material provided on the reflection layer is applicable as the sheet containing the material having a high reflectance. The configuration with the seal can more easily form the reflection member 3 than the configuration with paint or plating can. As described above, the stacked layer or the pasted film that reflects light having been emitted from the light source 14 and having traveled in the curved portion 22 of the light guide 2 is applicable as the reflection member 3. The configuration of the reflection member 3 is not specifically limited. Any configuration that reflects light having a wavelength that is emitted from the light source 14 may be adopted. The higher the reflectance of the reflection member 3, the more preferable the configuration is. For example, it is preferable that the reflectance be 85% or higher, and it is more preferable that the reflectance is 90% or higher.

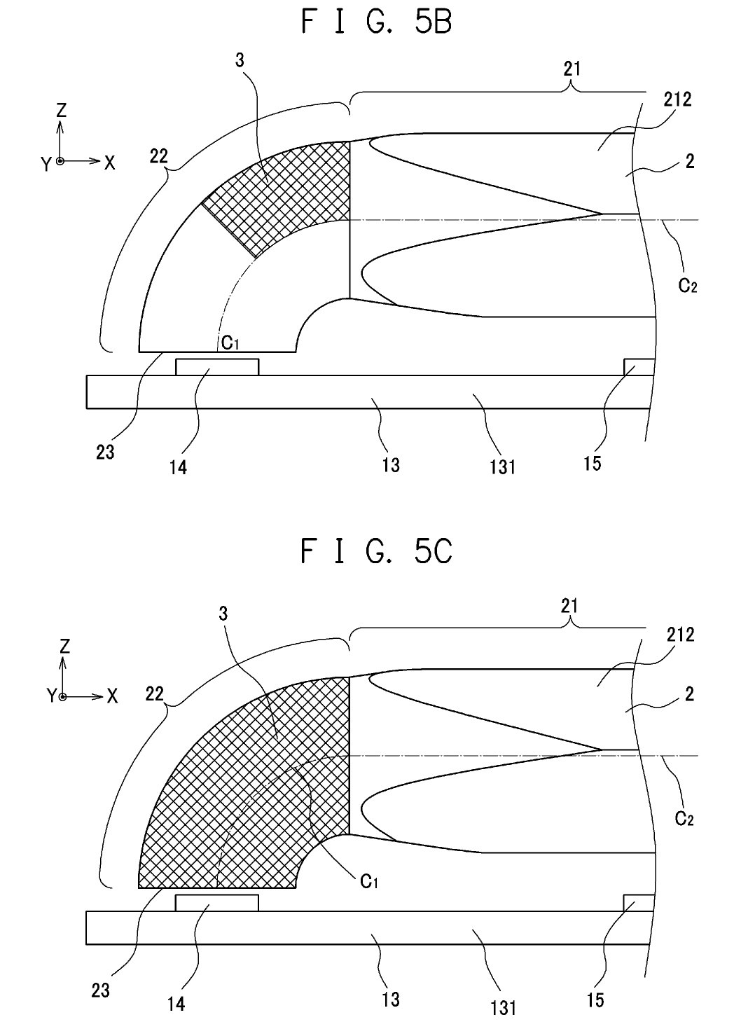

Next, an example of the predetermined range where the reflection member 3 is provided is described with reference to FIGS. 5A to 5C. FIGS. 5A to 5C are diagrams schematically showing the example of the predetermined range provided with the reflection member 3, and are side views in the sub-scan direction. In FIGS. 5A to 5C, the range to which a mesh pattern is applied indicates the range where the reflection member 3 is provided (this is applicable also to FIGS. 1 and 2, and represents FIG. 5A).

FIG. 5A shows an example of a configuration provided with the reflection member 3 on the upper part of the curved portion 22. Such a configuration can suppress leaking light without increasing the range provided with the reflection member 3. Many components of light incident on the light entering surface 23 is first reflected at the upper part of the surface of the curved portion 22 (see FIG. 4). The configuration provided with the reflection member 3 in the range where the light incident on the light entering surface 23 is first reflected can suppress leaking light. The upper part of the curved portion 22 is, for example, the outer side of the curve surface in the radial direction (outer side in the curvature radius direction) with respect to the position at which the width of the curved portion 22 (the dimension in the sub-scan direction) is the maximum.

FIG. 5B shows an example of a configuration where the reflection member 3 is provided at a position that is near to the end on the side close to the rod portion 21 and a part of the upper part of the curved portion 22. Such a configuration can suppress the light leaking from the curved portion 22 while narrowing the range provided with the reflection member 3 with respect to the example of the range in FIG. 5A. The reason is as follows. Many components of light incident on the light entering surface 23 is first reflected at the upper part of the surface of the curved portion 22 (see FIG. 4). In the sub-scan direction, the upper portion of the surface of the curved portion 22 is curved in an arc-shape manner. The direction of the surface changes from the vertical direction to the horizontal direction (main-scan direction) as the surface approaches the rod portion 21. Accordingly, the incident angle α of incident light varies according to the position, and becomes smaller as the position approaches the rod portion 21. If the incident angle α is larger than the critical angle, the incident light is totally reflected. Consequently, no leaking light occurs. On the other hand, if the incident angle α is smaller than the critical angle, a part of the incident light is not reflected and becomes leaking light. As described above, the incident angle α of the incident light becomes smaller as the position approaches the rod portion 21. Consequently, leaking light is difficult to occur on a side near to the light entering surface 23 in the upper portion of the curved portion 22. The leaking light is prone to occur as the position approaches the rod portion 21. The reflection member 3 is provided at a position that is near to the end on the side close to the rod portion 21 in the upper part of the curved portion 22. In particular, a configuration is adopted that includes the reflection member 3 so as to include the range where the incident angle α of the light being incident first (i.e., except light reflected by another position and being incident) is smaller than the critical angle in light having been emitted from the light source 14 and having entered the light entering surface 23. Such a configuration can suppress leaking light.

FIG. 5C shows an example of a configuration provided with the reflection member 3 on the entire part of the curved portion 22. As shown in FIG. 5C, a configuration may be adopted where the reflection member 3 is provided on the entire surface of the curved portion 22. Such a configuration can suppress the light leaking from the curved portion 22. In particular, in the example shown in FIG. 5C, the reflection member 3 is provided also on the lower side of the curved portion 22 (the center of the curved surface in the radial direction). Consequently, the leaking light on the lower side can also be suppressed. As described above, many components of light incident on the light entering surface 23 are first reflected at the upper part of the surface of the curved portion 22 (outer side of the curved surface in the radial direction). A part of the reflected light sometimes enters the lower part of the surface of the curved portion 22 (the center side of the curved surface in the radial direction). Consequently, the configuration including the reflection member 3 provided also at the lower part of the curved portion 22 can prevent not only light that enters the light entering surface 23 and enters on the surface of the light guide 2 first from becoming leaking light, but also light reflected by the surface one time or more from becoming leaking light. For example, in the case of the configuration shown in FIG. 5C, the reflectance of the reflection member 3 is 98%, this case has the amount of light 1.28 times as much as that in a case where the reflection member 3 is not provided. The lower part of the surface of the curved portion 22 is the center side of the curved surface in the radial direction. This part is, for example, the center side of the curved surface in the radial direction (center side in the curvature radius direction) with respect to the position at which the width of the curved portion 22 (dimension in the sub-scan direction) is the maximum.

As described above, the reflection member 3 is provided so as to be in close contact with a predetermined range of at least a part of the surface of the curved portion 22, thereby allowing leaking light to be suppressed. In this case, a configuration is preferable that the reflection member 3 be provided in the range that is a part of the upper part (outer side of the curved surface in the radial direction) of the curved portion 22 and includes the part near to the end on the side close to the rod portion 21. Furthermore, the configuration may be adopted that includes the reflection member 3 provided not only for a part of or the entire upper part of the curved portion 22 (the outer side of the curved surface in the radial direction) but also for the lower part of the curved portion 22 (the center side of the curved surface in the radial direction). Such a configuration can suppress leaking light, and facilitate increase in the amount of light emitted from the light emission surface 212 toward the reading line O on the object P to be illuminated (prevention of reduction). Suppression of leaking light can reduce the waste of light, thereby allowing reduction in power consumption to be facilitated. Furthermore, prevention of leaking light can suppress stray light caused by the leaking light. Consequently, improvement in reading image quality can be facilitated.

The predetermined range provided with the reflection member 3 has been described with reference to FIGS. 5A to 5C. However, the range provided with the reflection member 3 is not limited to the range shown in FIGS. 5A to 5C. For example, the position where leaking light is prone to occur differs according to the specific shape of the curved portion 22 of the light guide 2. Accordingly, the predetermined range provided with the reflection member 3 can be determined according to the specific shape of the curved portion 22. For example, FIG. 5C shows the configuration where the reflection member 3 is provided on the entire surface of the curved portion 22. Alternatively, another configuration may be adopted where this member is provided on a part of or the entire curved surface of the curved portion 22 on the center side in the radial direction and on a part of the outer side in the radial direction. More specifically, a configuration may be adopted where the reflection member 3 is provided on a part of or the entire curved surface of the curved portion 22 on the center side in the radial direction and on a portion that is a part of the outer side in the radial direction and is near to the end on the side close to the rod portion 21 (see FIG. 5B). Another configuration may be adopted where the reflection member 3 is provided on a part of or the entire curved surface of the curved portion 22 on the center side in the radial direction and on a portion that is a part of the outer side in the radial direction and is near to the end on the side close to the light entering surface 23. Yet another configuration may be adopted where the reflection member 3 is provided on the entire curved surface of the curved portion 22 on the center side in the radial direction and on a portion at an intermediate position between the end near to the side close to the light entering surface 23 and the end on the side close to the rod portion 21. In these cases, a configuration is preferable where the reflection member 3 be provided for the entire curved surface of the curved portion 22 on the center side in the radial direction. Alternatively, a configuration where this member is provided for a part thereof may be adopted.

### (Operation of Image Sensor Unit)

Here, a reading operation of the image sensor unit 1 is described. The light source 14 sequentially emits light beams having respective colors. The light emitted from the light source 14 enters the inside of the light entering surface 23 of the light guide 2, travels in the curved portion 22, and reaches the rod portion 21. The light having reached the rod portion 21 travels toward the distal end in the main-scan direction. The light traveling through the rod portion 21 is diffused by reflected by the light diffusion surface 211. The light having traveled in the rod portion 21 of the light guide 2 is emitted from the light emission surface 212 of the light guide 2 toward the reading line O of the object P to be illuminated (see FIG. 3). The light emission surface 212 has a shape elongated in the main-scan direction. Consequently, the light emitted from the light emission surface 212 is linear light elongated in the main-scan direction. The light reflected by the object P to be illuminated transmits through the light condenser 12 and is focused on the light receiving surface of the image sensor 15. The image sensor 15 detects the light focused by the light condenser 12 and converts the light into an electric signal. The image sensor unit 1 repeats the operation of illuminating the object P to be illuminated with light and detecting the reflected light periodically in a short time period while the object P to be illuminated is relatively moved in the sub-scan direction. According to such an operation, the image sensor unit 1 reads a predetermined pattern provided for the object P to be illuminated (e.g., hologram) as a visible light image, and reads an infrared ray image and an ultraviolet ray image of the object P to be illuminated.

### <Paper Sheet Distinguishing Apparatus>

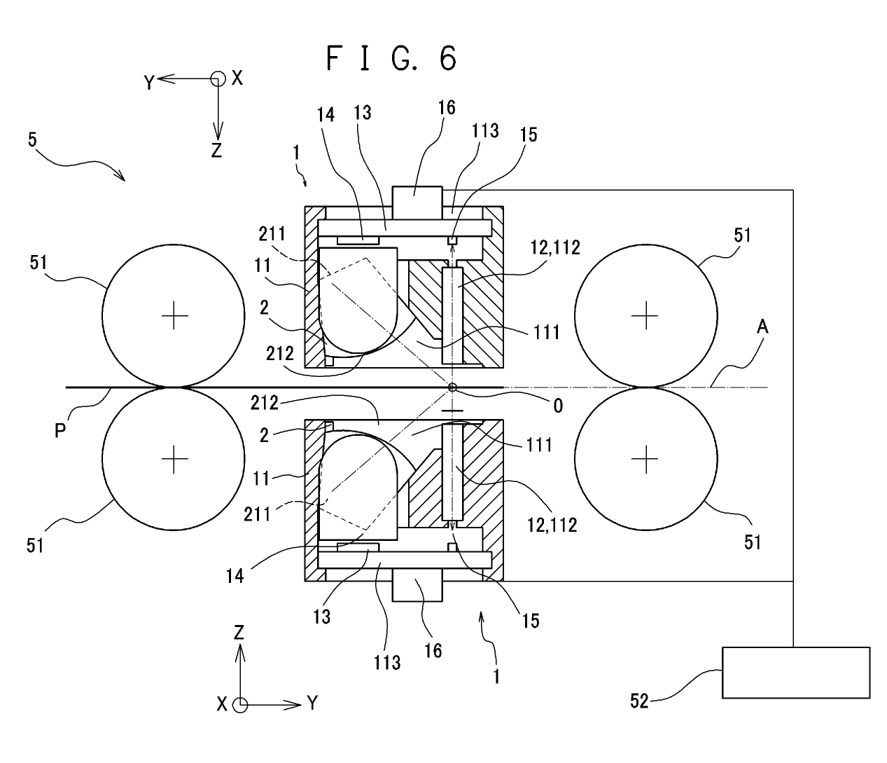

Next, a paper sheet distinguishing apparatus 5 to which the image sensor unit 1 is applied is described with reference to FIG. 6. FIG. 6 is a diagram schematically showing a configuration example of a main part of the paper sheet distinguishing apparatus 5, and is a diagram showing a section on a plane rectangular to the main-scan direction.

The paper sheet distinguishing apparatus 5 emits light toward a paper sheet or the like, which is the object P to be illuminated, for example, a bill, reads the light from the bill, and distinguishes the type and authentication of the bill using the read light. The light source 14 provided on the main circuit board 13 of the image sensor unit 1 applied to the paper sheet distinguishing apparatus 5 can emit visible light, infrared rays, and ultraviolet rays.

As shown in FIG. 6, the paper sheet distinguishing apparatus 5 includes two image sensor units 1, conveyance rollers 51 that convey a bill, and an image distinguishing unit 52 serving as distinguishing means wired and connected to the connector 16. In the paper sheet distinguishing apparatus 5, a conveyance path A for conveying the bill in the sub-scan direction is set. The two image sensor units 1 are provided so as to be intervened by the bill conveyance path A. The upper focal point F (on the bill side) of the light condenser 12 is set at the center of conveyance path A in the vertical direction.

The operation of the paper sheet distinguishing apparatus 5 having such a configuration is as follows. Each of the two image sensor units 1 applied to the paper sheet distinguishing apparatus 5 reads the predetermined pattern provided on the bill as a visible light image according to the operation described above. Furthermore, an infrared ray image of the bill is read, and an ultraviolet ray image of the bill is read. The light emitted from the light emission surface 212 of the light guide 2 of one of the image sensor units 1 passes through the bill and enters the light condenser 12 of the other image sensor unit 1 and focuses on the light receiving surface of the image sensor 15 of the other image sensor unit 1. The image sensor 15 of the other image sensor unit 1 reads the received transmission light as a visible light image, an infrared ray image and an ultraviolet ray image. As described above, the paper sheet distinguishing apparatus 5 can perform reflection reading of both the sides of the bill and transmission reading thereof.

Subsequently, the image distinguishing unit 52 authenticates the bill by comparing a genuine bill image obtained by illuminating a bill that is a prepared genuine bill with visible rays, infrared rays and ultraviolet rays, with the visible light image, the infrared ray image and the ultraviolet ray image of the bill that is determination targets during authenticity determination. This is because the bill that is a genuine bill is provided with a region whose images obtained with visible light, infrared rays and ultraviolet rays are different from each other. Configuration elements identical to those of the conventional paper sheet distinguishing apparatus are applicable to portions whose description and illustration are omitted. The image distinguishing unit 52 may have a configuration provided on the main circuit board 13 of the image sensor unit 1.

Here, the configuration where the paper sheet distinguishing apparatus 5 includes two image sensor units 1 has been exemplified. Alternatively, the paper sheet distinguishing apparatus 5 according to the embodiment of the present invention is not limited to the configuration including the two image sensor units 1. For example, instead of one of the two image sensor units 1, a transmission light source may be included. That is, the paper sheet distinguishing apparatus 5 may have a configuration that includes one image sensor unit 1, and a transmission light source provided to face the image sensor unit 1. In this case, the transmission light source can illuminate the reading line O on the bill with linear light having a predetermined wavelength range, in a manner analogous to that of the image sensor unit 1. Such a configuration can perform reflection reading of one side of the bill and transmission reading of the bill. Another configuration may be adopted where the paper sheet distinguishing apparatus 5 includes one image sensor unit 1 but includes no transmission light source. In this case, the paper sheet distinguishing apparatus 5 can perform reflection reading of one side of the bill.

In this embodiment, the configuration has been described that emits the visible light, infrared rays and the ultraviolet rays to read the bill as the visible light image, the infrared ray image and the ultraviolet ray image. The configuration is not limited thereto. For example, a configuration may be adopted that emits one or two types of the visible light, the infrared rays and the ultraviolet rays. The configuration where a bill is applied as a paper sheet that is the object P to be illuminated has been described. However, the type of the paper sheet is not limited thereto. For example, various securities and ID cards can also be read.

### <Image Reading Apparatus (Image Forming Apparatus)>

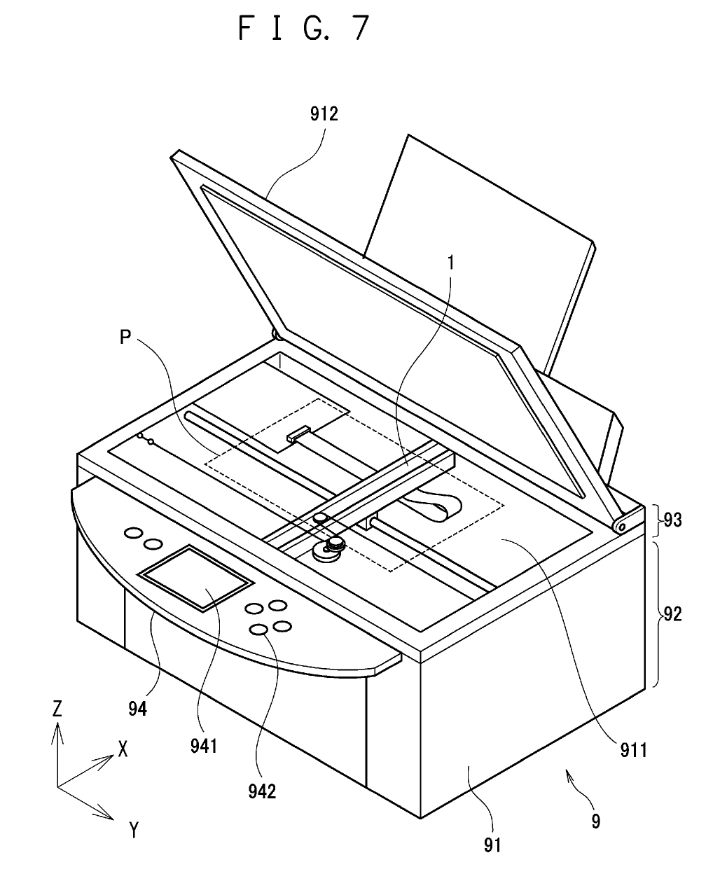

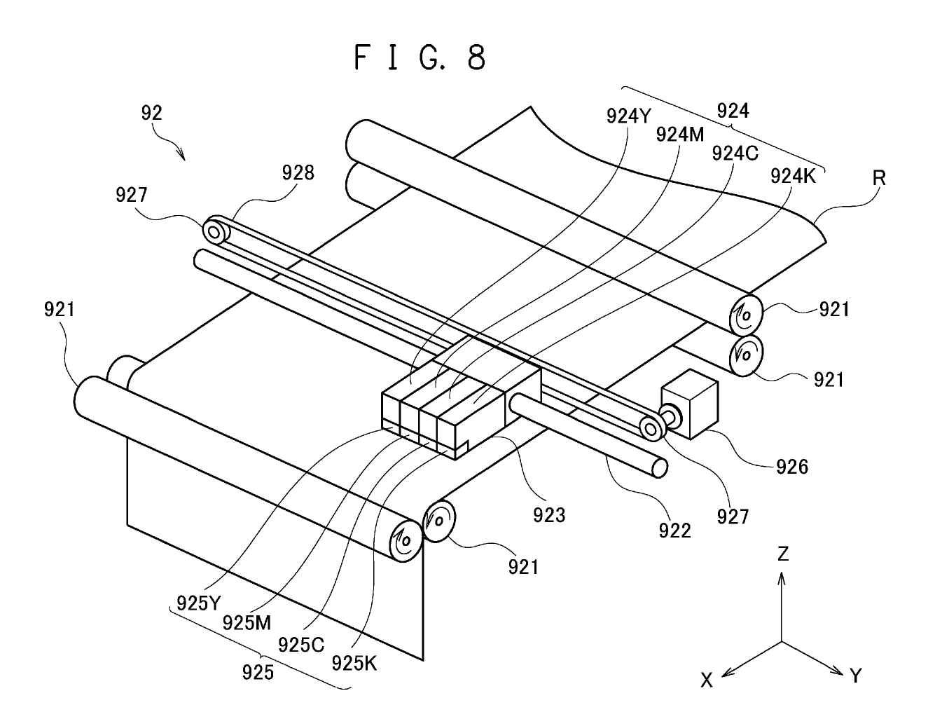

Next, a configuration example of an image reading apparatus 9 according to an embodiment of the present invention is described with reference to FIGS. 7 and 8. Here, a copier (an image forming apparatus that has an image reading function) that includes an image reading portion 93 and an image forming unit 92 is exemplified as the image reading apparatus 9. The image sensor unit 1 according to the embodiment of the present invention is applied to the image reading apparatus 9 according to the embodiment of the present invention. FIG. 7 is a perspective view of an appearance of the image reading apparatus 9 according to the embodiment of the present invention. FIG. 8 is a perspective view showing the image forming unit 92 provided in a casing of the image reading apparatus 9 according to the embodiment of the present invention in a manner where this portion is extracted. As illustrated in FIGS. 7 and 8, the image reading apparatus 9 is a multifunction printer (MFP) in which a flatbed type scanner and an inkjet type printer are integrated. The image reading apparatus 9 includes an image reading portion 93 serving as image reading means for reading an image, and an image forming unit 92 serving as image forming means for forming an image. An image sensor unit 1 is implemented in the image reading portion 93 of the image reading apparatus 9.

As illustrated in FIG. 7, the image reading apparatus 9 is provided with an operation portion 94. The operation portion 94 includes a display portion 941 that displays an operation menu and various messages, and various operation buttons 942 for operating the image reading apparatus 9.

The image reading portion 93 of the image reading apparatus 9 includes platen glass 911 on which the object P to be illuminated is mounted, a platen cover 912 openable with respect to the platen glass 911, the image sensor unit 1 according to the embodiment of the present invention, and a drive mechanism that drives the image sensor unit 1. Various publicly known configurations are applicable to drive mechanisms that drive the platen glass 911, the platen cover 912 and the image sensor unit 1 according to the embodiment of the present invention.

As illustrated in FIG. 8, the image forming unit 92 is provided in the casing 91 of the image reading apparatus 9. The image forming unit 92 includes conveyance rollers 921, a guide shaft 922, an inkjet cartridge 923, a motor 926, and a pair of timing pulleys 927. The conveyance rollers 921 are rotated by a drive force of a drive source, and conveys a print sheet R serving as a recording medium in the sub-scan direction. The guide shaft 922 is a rod-like member and is fixed to the casing 91 of the image reading apparatus 9 so that its axis can be in parallel to the main-scan direction of the print sheet R.

The inkjet cartridge 923 is slid on the guide shaft 922, thereby moves to and fro in the main-scan direction for the print sheet R. The inkjet cartridge 923 includes, for example, an ink tanks 924 (924Y, 924M, 924C and 924K) that include cyan C, magenta M, yellow Y and black K inks, and discharge heads 925 (925Y, 925M, 925C and 925K) provided for the respective ink tanks 924 (924Y, 924M, 924C and 924K). One of the pair of the timing pulleys 927 is attached to a rotation shaft of the motor 926. The pair of the timing pulleys 927 are provided at positions separated from each other in the main-scan direction for the print sheet R. A timing belt 928 is wound around the pair of the timing pulleys 927 in a parallel manner, and is connected to the inkjet cartridge 923 at a predetermined position.

The image reading portion 93 of the image reading apparatus 9 converts an image read by the image sensor unit 1 into an electric signal having a format suitable to printing. The image forming unit 92 of the image reading apparatus 9 drives the conveyance rollers 921, the motor 926, and the inkjet cartridge 923, on the basis of the electric signal converted by the image sensor unit 1 of the image reading portion 93, and forms an image on the print sheet R. Furthermore, the image forming unit 92 of the image reading apparatus 9 can form an image on the basis of the electric signal input from the outside. Any of the configurations identical to those of various publicly known printers is applicable to the configuration and the operation of the image forming unit 92 in the image reading apparatus 9. Consequently, the detailed description is omitted. The ink jet type image reading apparatus 9 has been described as the image forming unit 92. Alternatively, any of various types, such as electrophotographic, thermal transfer, and dot impact types, may be adopted.

The embodiments of the present invention have been described above in detail. However, the embodiments described above are only concrete examples for implementing the present invention. The technical scope of the present invention is not limited to the embodiments described above. The present invention can be implemented in various forms in a range without departing from the technical spirit or main features thereof.

For example, in the embodiment, the multifunction printer (image forming apparatus) includes the image reading portion and the image forming portion as the image reading apparatus. The image reading apparatus is not limited to such a configuration. The image reading apparatuses of the present invention encompass apparatuses having image reading functions, such as various copiers, facsimiles and scanners (e.g., a flatbed scanner, a sheet feed scanner, a handy scanner). The embodiment of the present invention shows the image forming apparatus that includes the image reading means and the image forming means, as the image reading apparatus. However, the present invention encompasses the image reading apparatus that does not include the image forming means.

The present invention is a technique effective to the image sensor unit, and the paper sheet distinguishing apparatus and the image reading apparatus that include the image sensor unit. According to the present invention, leaking light from the curved portion of the light guide can be suppressed, and reduction in the amount of light emitted toward the object to be read can be suppressed.

The present invention can suppress light leaking from the curved portion of the light guide.

What is claimed is:

1. An image sensor unit, comprising:
a light source;
a light guide that guides light from the light source to an object to be illuminated; and
a photoelectric conversion element that converts light from the object to be illuminated into an electric signal,
wherein the light guide includes a rod portion, and a curved portion provided at an end of the rod portion,
the curved portion includes a light entering surface on which the light emitted from the light source is incident, and guides the light to the rod portion by changing a traveling direction of the light having entered the light entering surface,
the image sensor unit further comprises a reflection member that reflects the light, and
the reflection member is in close contact with a surface of the curved portion.

2. The image sensor unit according to claim 1, wherein the reflection member is a pasted film pasted on the surface of the curved portion.

3. The image sensor unit according to claim 1, wherein the reflection member is a stacked layer stacked on the surface of the curved portion.

4. The image sensor unit according to claim 1, wherein the reflection member is provided on an outer side of a curve in a radial direction on the surface of the curved portion.

5. The image sensor unit according to claim 1, wherein the reflection member is provided on an outer side of a curve in a radial direction on the surface of the curved portion and a position near to an end on a side close to the rod portion.

6. The image sensor unit according to claim 1, wherein the reflection member is provided on the entire surface of the curved portion.

7. A paper sheet distinguishing apparatus, comprising:
an image sensor unit;
image reading means that relatively moves the image sensor unit and an object to be illuminated that is a paper sheet, while reading light from the object to be illuminated; and
distinguishing means that distinguishes authenticity of the object to be illuminated,
wherein the image sensor unit is the image sensor unit according to claim 1.

8. An image reading apparatus, comprising:
an image sensor unit; and
image reading means that relatively moves the image sensor unit with respect to an object to be illuminated, while reading light from the object to be illuminated,
wherein the image sensor unit is the image sensor unit according to claim 1.

9. An image forming apparatus, comprising:
an image sensor unit;
image reading means that relatively moves the image sensor unit with respect to an object to be illuminated, while reading light from the object to be illuminated; and
image forming means that forms an image,
wherein the image sensor unit is the image sensor unit according to claim 1.
